(19) United States
(12) Patent Application Publication
(10) Pub. No.: US 2005/0140331 A1
(43) Pub. Date: Jun. 30, 2005

(54) Solar bag with internal battery

(76) Inventor: Shayne Laurence McQuade, New York, NY (US)

Correspondence Address: ELLIOT FURMAN, 150 CLAREMONT AVE, #1D, NEW YORK, NY, 10027, US

(21) Appl. No.: 11/014,040

(22) Filed: Dec. 16, 2004

(30) Foreign Application Priority Data
Dec. 24, 2003 (CA) 2,454,221

(51) Int. Cl. H02J 7/32

(52) U.S. Cl. 320/101

(57) ABSTRACT

A bag, such as a backpack, comprises a battery internal to the bag, a solar panel assembly affixed to the front exterior of the bag, and a universal connecting system wire. The solar panel assembly includes a solar panel. The solar panel charges the battery and also provide power to an electronic device. The universal connecting system wire connects the battery to the electronic device. The solar panel assembly protects the solar panel from damage. Wire routing channels are provided for routing the universal connecting system wire from the battery to the electronic device. The battery may be charged from an external source.

This application claims the benefit of Canadian Provisional Patent Application No. 2,454,221, filed Dec. 24, 2003, which is hereby incorporated by reference.

### BACKGROUND

The use of portable electronic devices such as digital cameras, digital music players, cell phones, GPS devices, personal digital assistant devices (PDAs), laptop computers, and the like has increased dramatically over the years. It is commonplace for owners of these devices to rely exclusively on them to communicate with others and maintain order and efficiency in their professional and personal lives. These devices, and ones like them, have strict power requirements and more often than not require the use of proprietary batteries and battery chargers to keep the devices working. A dead battery renders these devices useless, wreaking havoc on a user relying on their device for entertainment, communications, or scheduling of events.

In order to avoid a dead battery, many users purchase extra proprietary batteries along with proprietary chargers at great expense and inconvenience. Battery chargers are typically AC chargers which must be plugged into a wall socket, or car chargers plugged into an automobile cigarette lighter socket. The extra batteries and chargers must be carried by the user, along with the electronic device, thereby diminishing the overall portability and convenience of the device. Furthermore, the electronic device becomes immobile and tethered by wire to a wall or car while charging.

It is known that solar panels can been used to charge batteries. For example, U.S. Pat. No. 5,701,067 describes a bag, such as a mountain climbing type backpack, with solar cells provided on an upper flap portion of the bag. Rechargeable batteries retained within the bag are charged by the solar cells. Electronic equipment is stored in the bag for transport. Due to the size requirements and fragility of the solar panels used, one object of U.S. Pat. No. 5,701,067 is to provide solar panels which can be folded and stored in the bag when the batteries are not being charged. While storing the solar panels in the bag helps prevent the solar cells from being damaged, it dramatically reduces the usefulness of the bag; a user of the backpack must physically remove the solar panels from to the bag to charge the batteries, and unless they do so no charge can be generated by the panels. Furthermore, the user must be aware of when the batteries need charging or otherwise risk fully depleting the batteries, thereby rendering any electronic device using those batteries useless.

Another bag having a solar panel for providing power to an electronic device is “The Reactor” Solar Backpack from Innovus Designs, Inc. “The Reactor” has a single solar panel, or single block of solar panels, permanently affixed to the front of the bag. The solar panel is connected to a 12 volt automotive charging socket.

An electronic device can be powered by plugging a 12 volt automotive adapter into the socket. Unfortunately, automotive adapters are necessarily large, sometimes even larger than the device they are designed to power. Furthermore, “The Reactor”, has no internal battery storage. Without an internal battery, electronic devices cannot be powered by the bag unless the solar panel is exposed to light. Also, power supplied to an electronic device is unregulated and bursty as the solar panel is exposed to varying degrees of light.

Additionally, the use of a single solar panel in a bag such as “The Reactor” results in a bag whose front is inflexible and rigid. This rigidity results in a less versatile bag, and leads to a high incidence of solar cell damage during real-world bag use. Also, a single panel provides no power system redundancy; that is damage to the panel results in total failure of the power system, thus rendering the bag useless for its primary and intended purpose. Once damaged the entire solar cell must be replaced which is costly and may not be practical given the mounting system used in the bag.

### SUMMARY

It is therefore an object of this invention to provide a bag with an internal battery that can be charged from multiple sources such as DC, AC, and solar power sources.

It is another object of this invention to provide such a bag that can recharge electronic devices without being tethered to a wall or car.

It is also an object of this invention to provide such a bag comprising solar panels for charging the internal battery and for powering or charging electronic devices.

It is another object of this invention to provide such a bag wherein the solar panels are permanently mounted on the outside of the bag in a manner that minimizes damage to the solar panels.

It is still another object of this invention to provide such a bag that can power electronic devices or charge electronic devices having different electrical power requirements.

Briefly, these and other objects of the present invention are accomplished by providing a bag with an internal battery for storing and powering electronic devices. The bag comprises a solar panel assembly connected to the exterior of the bag, a battery electrically connected to the solar panel, and a universal connected system wire electrically connected to the battery. The universal connecting system wire may be routed through the bag via a bag wire routing channel connected to the interior of the bag. The solar panel assembly comprises at least one solar panel. The solar panel may be a rigid solar panel or a flexible solar panel. The solar panel assembly comprises an assembly front, a reinforcing ring attached to the assembly front, and an assembly back. The assembly front comprises an aperture for displaying the solar panel. The assembly front and assembly back are connected to form a solar panel pocket where the solar panel is secured. The battery has a variable output that is selectable among a plurality of output voltages. The universal connecting system wire comprises a universal plug connector that mates with a device plug. A strap may be connected to the bag. The strap may include a strap wire routing channel.

The foregoing paragraphs have been provided by way of general introduction, and they should not be used to narrow the scope of the following claims. Further objects and advantages of the present invention will become apparent from the following detailed description and drawings. The preferred embodiments will now be described with reference to the attached drawings.

### BRIEF DESCRIPTION OF THE DRAWINGS

FIG. 1 is a front perspective view of a solar bag.

FIG. 2 is a back view of the solar bag including shoulder straps.

FIG. 3 is a schematic of the power system of the solar bag.

FIG. 4 is a view of the interior of the solar bag.

FIG. 5 is an exploded perspective view of a solar panel assembly.

FIG. 6 is a cross sectional view of the solar panel assembly.

FIG. 7 is a perspective view of the solar panel assembly front with three apertures and three reinforcing rings for three solar cells.

FIG. 8 is a side view of the solar bag showing the angle between the solar panel assembly and the bag body.

FIG. 9 is a universal connecting system wire.

FIG. 10 is a top orthogonal view of a device plug.

### DETAILED DESCRIPTION OF THE PRESENTLY PREFERRED EMBODIMENTS

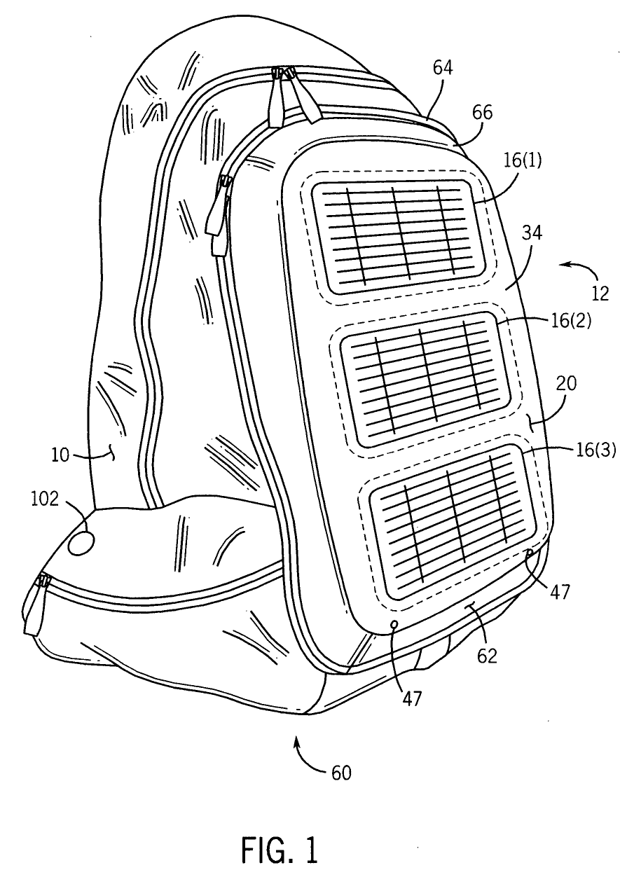

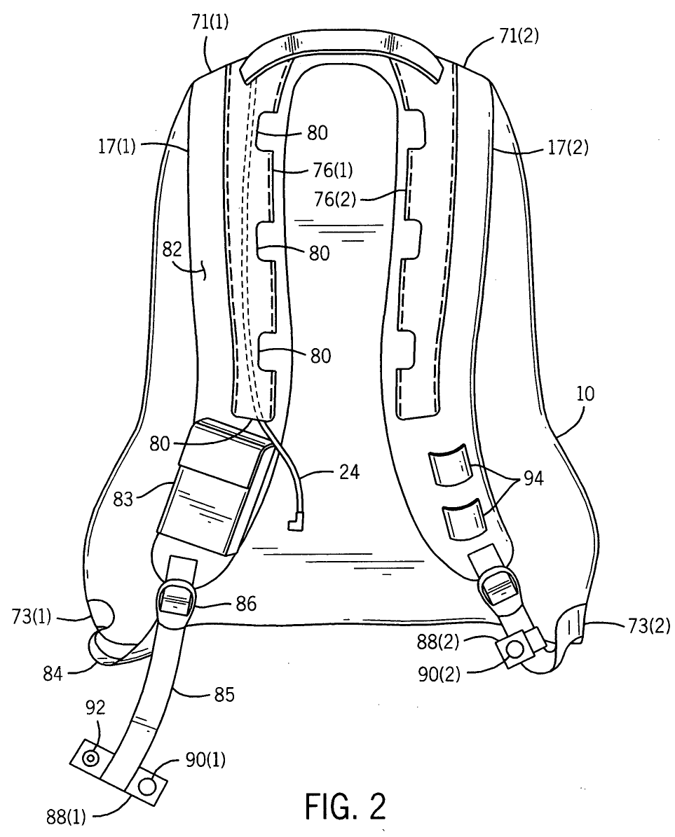

FIG. 1 shows a front perspective view of the solar bag. The bag has a bag body 10 and a bag front 12. The bag may include at least one strap (17 of FIG. 2) such as a shoulder strap. A solar panel assembly 20 is connected to the exterior of the bag. The solar panel assembly comprises at least one solar panel. Specifically, the bag comprises three solar panels 16(1), 16(2), and 16(3).

The solar panels may be electrically connected in series or in parallel. In one embodiment, the three solar panels 16(1), 16(2), 16(3) are electrically connected in parallel in order to increase the current output, and to provide redundancy in the event that a solar panel is damaged. The solar panels may be rigid solar panels, flexible solar panels, or a combination of rigid and flexible solar panels. The solar panels may be waterproof and scratch resistant. Additionally, the solar panels may be resistant to ultraviolet radiation and comprise protective coatings. In one embodiment the solar panel is a high efficiency monocrystalline solar cell having a dimension of 184 mm by 88 mm, weighing 120 grams, on a 3 mm aluminum/plastic substrate, having a cell efficiency of 17%, with an open circuit voltage of 12.5 V, a peak voltage of 10.2 V, a peak current of 1.36 mA, and a peak power output of 1.36 W under irradiance of 100 mW/cm\hat{ }2 with a spectrum of 1.5 air mass at 25 degrees Celsius.

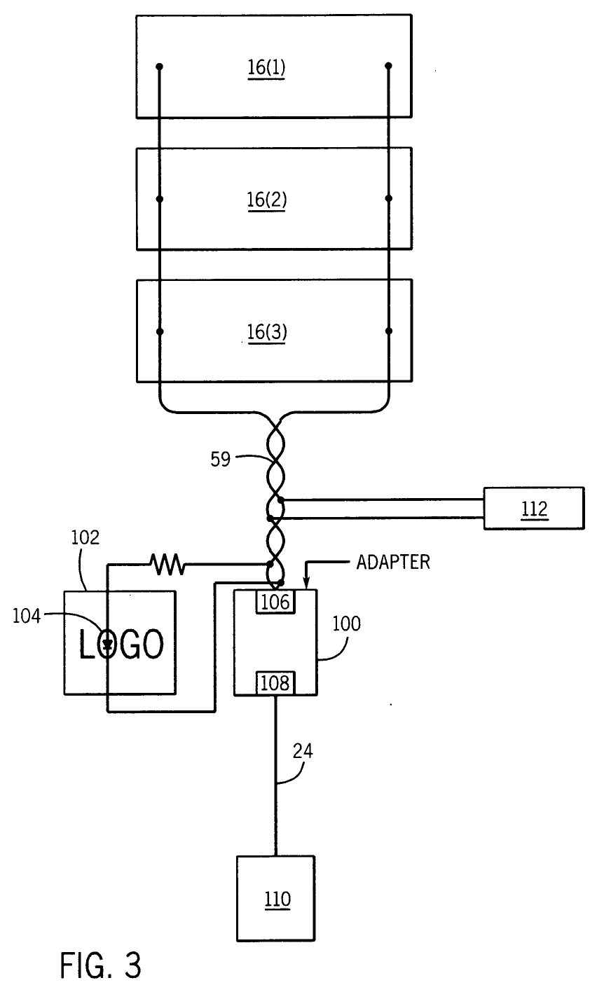

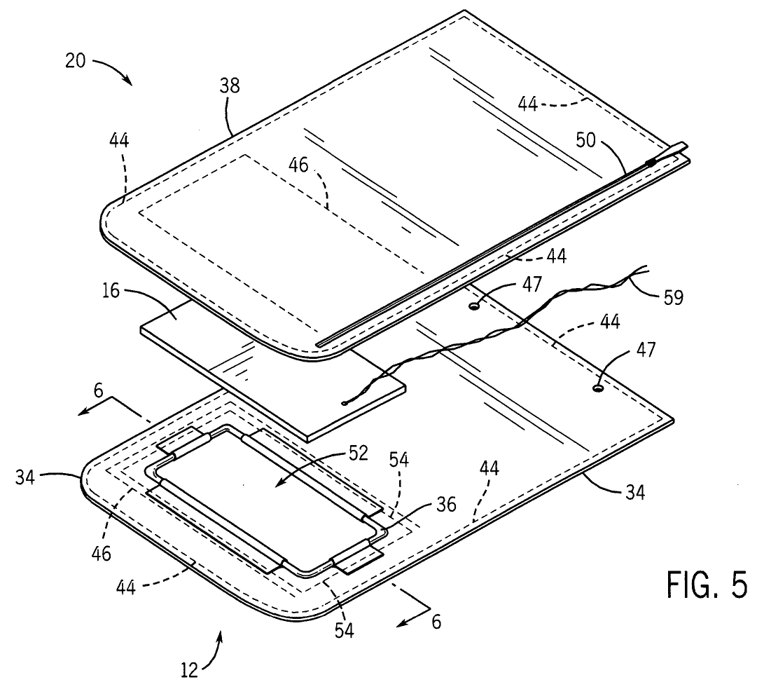

With reference to FIG. 3, a battery 100 is electrically connected to the solar panels 16 via charging system wires 59 (also shown in FIG. 5). The battery 100 is stored within the interior of the solar bag. The solar panels 16 are electrically connected in parallel. The battery 100 is thus charged by solar panels 16 when the solar panels are exposed to light. A universal connecting system wire 24 (also shown in FIGS. 2, 4 and 9) is electrically connected to the battery 100. An electronic device 110 such as a cell phone, a handheld computer, a personal digital assistant (PDA), a digital camera, a game machine, a portable music player, a portable media device, a flashlight, a light emitting diode, and the like may be connected to the battery 100 by universal connecting system wire 24.

A charge indicator 102 is connected to the solar panels 16 for indicating when the solar panels 16 are producing electricity, and accordingly when the battery 100 is being charged. In one embodiment the charge indicator comprises an identifying logo, such as a trademark or decorative design, with a light emitting diode integrated into the logo. For example, in FIG. 3, light emitting diode 104 is integrated into the “O” of charge indicator 102 having the identifying logo “LOGO”. In this manner. a portion of the identifying logo is illuminated when the battery is being charged.

A standard automotive cigarette lighter female adapter 112 may also be connected to the solar panels 16. Devices such as AC power inverters, battery chargers, and other adapters that normally plug into an automotive cigarette lighter may be plugged into the automotive adapter 112.

In one embodiment the battery 100 is a lithium-ion battery (LiIon) comprising an integrated charging circuit 106 providing an input to the battery 100, and an integrated voltage regulator output circuit 108 providing an output for the battery. Other types of batteries may be used such as nickel metal hydride (NiMH), nickel-cadmium (NiCd), and the like. The battery 100 may comprise removable battery cells, for example AA or AAA sized rechargeable batteries.

The battery 100 is charged by the solar panels, or alternately by using an AC charger or a car charger, and produces an output voltage on its output 108. The output voltage is adjustable to accommodate the voltage requirement of whichever electronic device 110 is being powered. In one embodiment, battery 100 provides voltage outputs 3.7 volts, 5 volts, 6 volts, and 7.2 volts. The battery 100 may also comprise a charging indicator, a battery charge level indicator, an integrated LED flashlight, and the like.

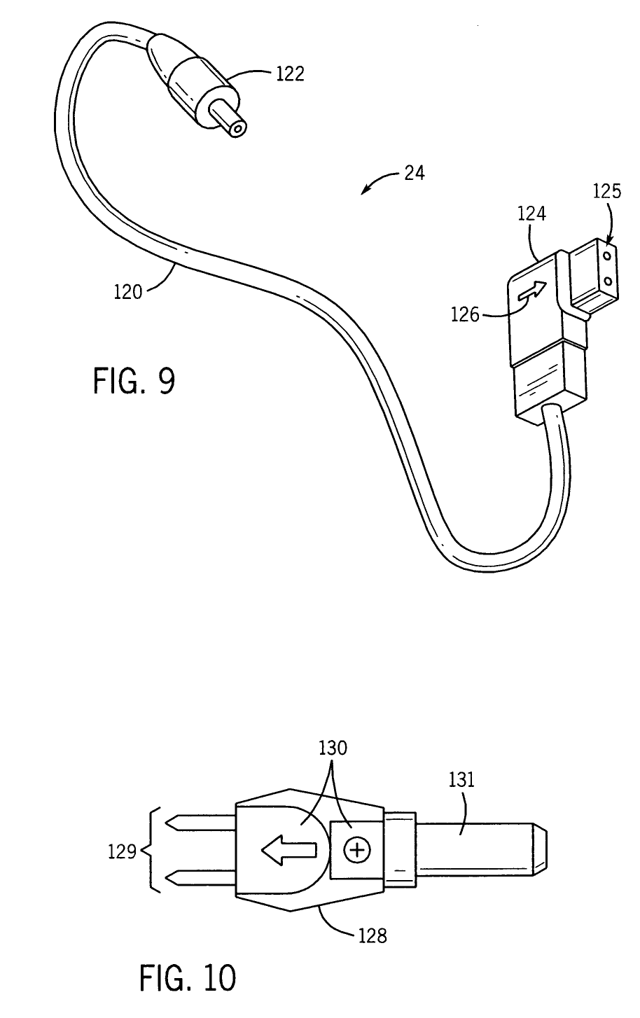

FIG. 9 shows the universal connecting system wire 24 comprising wires for carrying electric current 120, a battery connector 122 connected to one end of the wires 120, and a universal plug connector 124 connected to the other end of the wires 120. A device plug 128, shown in FIG. 10, is adapted to mate with the universal plug connector 124. The universal plug connector 124 comprises a symmetric female connector 125. One end of the device plug 128 comprises a symmetrical male connector 129 designed to mate with the symmetrical female connector 125. Since both connectors are symmetrical, the device plug 128 may be plugged into the universal plug connector 124 in two directions, thereby changing the polarity of the output of the device plug 131. In the embodiment of FIG. 10, the output of the device plug 131 is a barrel connector.

The universal plug connector 124 comprises a polarity aligning mark 126. The device plug 128 also comprises a polarity aligning mark 130. The polarity aligning marks 126 and 130 are used to ensure that the device plug 128 is mated with the universal plug connector 124 to provide the correct polarity on the output of the device plug 131 for the type of electronic device 110 being powered. For example, in one embodiment the device plug has a polarity mark showing a positive (+) sign 130 with a circle around it indicating that the if that mark is aligned with the polarity mark 126 of universal plug connector 124 then the output of the device plug 131 will have a center positive output. There may be another mark on the opposite side of the device plug 128, for example a negative (−) sign with a circle around it, to indicate that if the device plug 128 is mated with universal plug connector 124 with the polarity aligning marks of each aligned then the output of the device plug 131 will be center negative.

Since different electronic devices 110 will have different power connector dimensions, a user may own a plurality of device plugs, each having an output 131 with different output dimensions and form factors. Examples of device plugs are barrel plugs, phone plugs, cell phone power plugs, PDA power plugs, camera power plugs, game machine power plugs, portable music player power plugs, portable media device power plugs, a plug comprising a light emitting diode flashlight, a plug comprising a universal serial bus connector, a plug connected to a power inverter, an automotive cigarette lighter socket, and the like. The device plug may also include circuitry such as charge circuitry and voltage monitoring and regulation circuitry to accommodate the charging requirements of the electronic device 110.

The wires 120 are insulated and of sufficient length to allow connection from the battery 100, which is stored in the interior of the bag, to the electronic device 110. If the electronic device 110 is not stored near the battery, the wires 120 should be of sufficient length to be routed through the bag wire routing channel 22 and, if necessary, through the strap wire routing channel 76, to the electronic device 110.

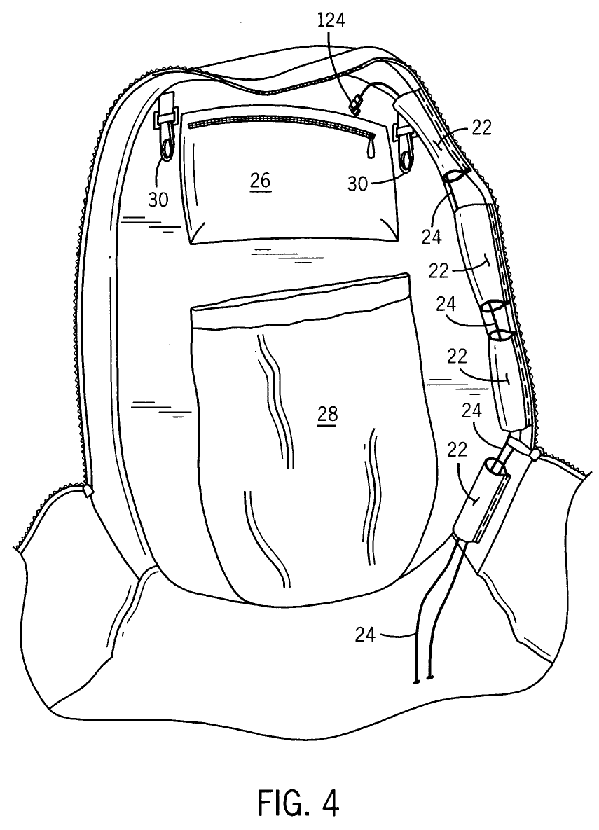

Turning now to FIG. 4, one embodiment of the interior of the bag is shown. The universal connecting system wire 24 is routed from the battery, through a bag wire routing channel 22. The universal connecting system wire 24 may emerge at any open point from the bag wire routing channel 24 within the interior of the bag body as shown, or may emerge outside the bag body as shown in FIG. 2. The interior of the bag body may also include various pockets 26, 28, clips 30, and other securing and holding devices such as elastic bands, slots, mesh bags, and the like. Clips 30 may be used for suspending a laptop sleeve for holding a laptop computer. Since the sleeve is suspended, the laptop is prevented from hitting the ground if the bag is dropped.

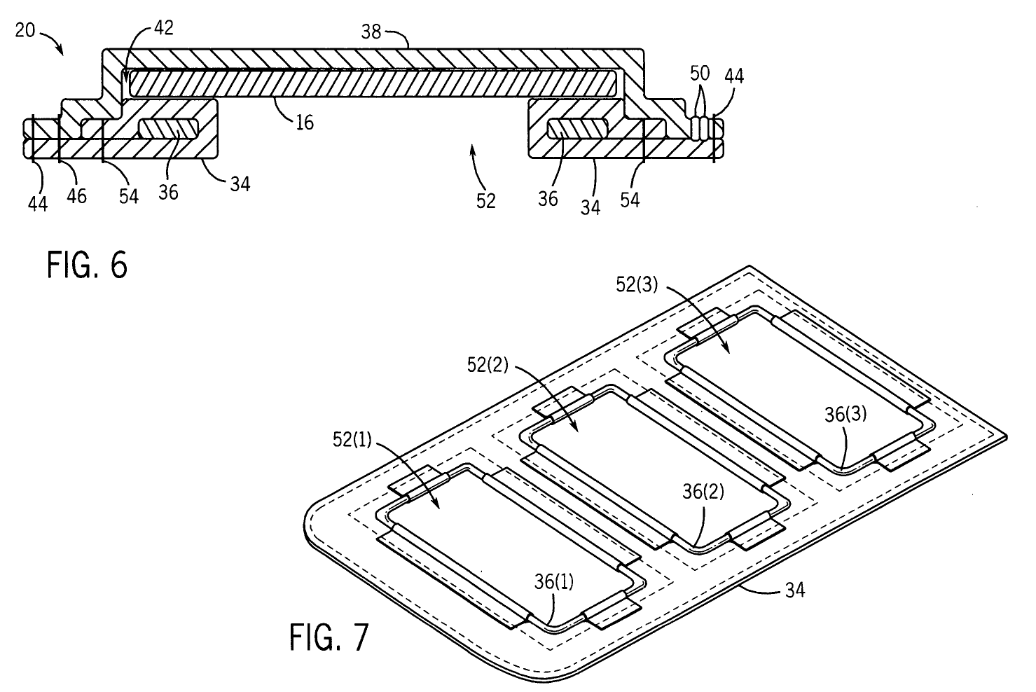

FIGS. 5 and 6 show the solar panel assembly 20 in different views. FIG. 5 in an exploded perspective view of the solar panel assembly. FIG. 6 is a cross sectional view. For simplicity of illustration, the solar panel assembly of FIG. 5 is shown with a single solar panel 16(1). It is clear, however, to those skilled in the art that more than one solar panel may be used merely by duplicating the components and construction of the solar panel assembly as shown and described below.

The solar panel assembly 20 comprises an assembly front 34, a reinforcing ring 36 attached to the assembly front 34, and an assembly back 38. The assembly front 34 comprises an aperture 52 for displaying the solar panel 16. The assembly back 38 is connected to the assembly front 34 to form a solar panel pocket (42 of FIG. 6) into which solar panel 16 is placed and secured between the reinforcing ring 36 and the assembly back 38. The assembly front 34 may further comprise water draining holes 47. The water draining holes permit the evacuation of any moisture that may accumulate in the solar panel assembly.

There are many ways to connect the assembly back 38 to the assembly front 34. In one embodiment the assembly back 38 is connected to the assembly front 34 by sewing the two together at sew points 44. The solar panel pocket 42 is formed by sewing the assembly back 38 to the assembly front at sew points 46. A zipper 50 is provided on the assembly back 38 to provide access to the solar panel pocket 42.

FIG. 6 show a cross sectional view of the solar panel assembly 20. As discussed, assembly back 38 is attached to assembly front 34 at sew points 44. The reinforcing ring 36 is secured to the assembly front 34 by folding over a portion of the assembly front 34 onto itself and over the reinforcing ring 36 and connecting at sew point 54 (also see FIG. 5). For additional strength, the reinforcing ring 36 may be glued to the assembly front 34 where the reinforcing ring 36 meets the assembly front 34. Many types of reinforcing rings may be use such as metal rings, plastic rings, carbon fiber rings, and rings made from alloys, synthetic materials, and natural materials.

Many solar panels may be added to solar panel assembly 20 simply by duplicating as described above the apertures, reinforcing rings, and securing and sew points for the additional apertures, rings, and solar panel pockets. FIG. 7 is a perspective view of the solar panel assembly front 34, with three apertures 52(1), 52(2), 52(3), and three reinforcing rings 36(1), 36(2), 36(3). The assembly front 34, apertures 52, and reinforcing rings 36 form three solar panel pockets when assembled with an assembly back (not shown), as detailed above. The three solar panels are electrically connected in parallel to triple the current output over what would be provided by a single solar panel. By building a solar panel assembly with multiple solar panels as above, the solar panel assembly remains flexible, that is, it has the ability to bend and flex at all points around the solar panels, while at the same time providing the power output capacity equal to or greater than one single large solar panel encompassing the same aggregate area as the three solar panels. The solar panels remain secure and resistant to damage within their individual solar panel pockets. Furthermore, if one solar panel is damaged, the solar panel assembly continues to operate and generate power. This would not be the case with a single large solar panel.

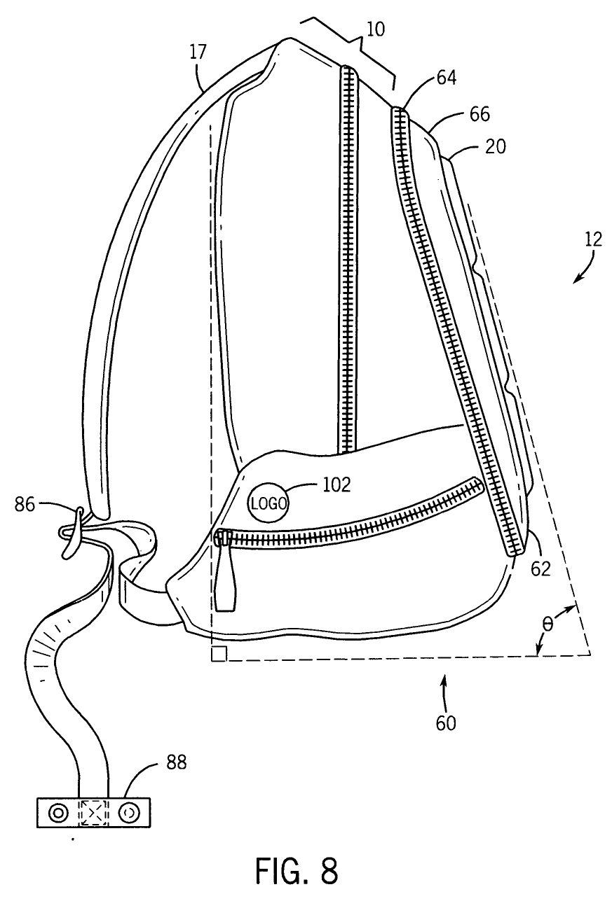

As mentioned, the solar panel assembly 20 is attached to the bag exterior. The solar panel assembly 20 is permanently attached on one of its ends to the bag (62 of FIGS. 1 and 8), for example by sewing one end of the solar panel assembly 20 in the vicinity of the bottom (60 of FIG. 1) of the bag. The remaining sides of the solar panel assembly are removeably attached to the bag body by, for example, a zipper (64 of FIGS. 1 and 8). This embodiment has the advantage that the solar panel assembly 20 forms an additional storage compartment (66 of FIGS. 1 and 8) with the bag body (10 of FIGS. 1 and 8). This storage compartment can be used to organize and store items such as the battery and electronic devices. In another embodiment, the solar panel assembly 20 is permanently attached to the bag, by for example sewing the entire solar panel assembly 20 to the front of the bag.

Referring to FIG. 8 which shows a side view of the solar bag, the solar panel assembly 20 is connected to the bag body 10 such that the solar cells of the solar panel assembly 20 form a solar panel assembly angle θ of around between 55 degrees and 80 degrees. At such an angle, the solar cells are more optimally angled to receive the greatest solar energy, and therefore output the greatest power at the greatest efficiency when the bag being carried, worn, or is placed down.

Turning back to FIG. 2, the back view of the solar bag is shown. As mentioned above, the bag may comprise at least one strap. In the embodiment of FIG. 2, the bag comprises two straps, 17(1) and 17(2). The straps 17 are shoulder straps for carrying the bag over one's shoulders, as in a backpack type bag. Examining strap 17(1), it is connected to a first end of the bag at a first location 71(1), and at a second end of the bag at a second location 73(1). Strap 17(2) is similarly connected at locations 71(2) and 73(2).

The straps comprise strap wire routing channels 76. Referring to strap wire routing channel 76(1), the channel comprises exit apertures 80. A wire, such as the universal connecting system wire 24 is routed from the battery, through the bag wire routing channel and through the strap wire routing channel 76(1), to exit at one of the exit apertures 80. In one embodiment, strap 17(1) also comprises a phone pouch 83 connected to the strap. The phone pouch 83 may be permanently or removeably connected. The universal connecting system wire 24 emerges from the strap wire routing channel 76(1) close to phone pouch 83 as shown in FIG. 2.

Examining strap 17(1) in greater detail, the strap comprises a padded shoulder portion 82, a buckle 86 connected to the padded shoulder portion 82, and an adjustable strap webbing portion 84 and 85. The adjustable strap webbing portion 84 and 85 is engaged through the buckle 86 and the strap 17(1) may be adjusted in length by lengthening or shortening webbing portion 84. For example, strap 17(1) may be lengthened by sliding webbing portion 85 toward and through the buckle, thereby lengthening webbing portion 84.

A means for securing webbing 88(1) is connected to the end of webbing 85. The means for securing webbing 88(1), which comprises a piece of webbing 88(1) secured at the end of webbing portion 85 and perpendicular to webbing portion 85, allows the webbing portion 85 to be neatly folded and secured onto itself. Without means 88(1), webbing portion 85 hangs freely. Means for securing webbing 88(1) further comprises a snap, the top portion of the snap shown as 90(1) and the bottom portion of the snap as 92. To secure extra webbing portion 85, extra webbing 85 is wrapped around portion 88(1) and snap portions 90(1) and 92 are snapped together. Strap 17(2) shows the extra webbing secured and the means for securing webbing 88(2) snapped together with snap 90(2).

Straps 17(1) and 17(2) may also include loops and pockets such as loops 94 for securing other devices and articles such as phones, pens, clips, flashlights, and the like to the straps.

The solar bag interior and exterior, solar panel assembly back and front, the straps, pockets, and other portions of the bag are constructed of lightweight, high strength fabrics and materials. The fabrics and materials may be resistant to ultraviolet light and further may be tear and stain resistant. In one embodiment the fabrics are a combination of 840D nylon, high density foam, and neoprene. Other materials may be used by themselves or in combination such as, rubber, natural fabrics, synthetic fabrics, recycled tires and inner tubes, polyurethane, recycled PET, and the like.

The bag may take many forms in addition to the backpack style bag discussed. The bag may be a messenger bag, a shoulder bag, or any other bag of sufficient size and form to allow mounting of the solar panel. The bag may be constructed of soft and flexible materials as discussed, or may be constructed of solid and rigid materials such as plastic. The bag may be constructed of a combination of soft and rigid materials. For example, the bag may have a flexible back and a solid front. The solar panel assembly front or back may be constructed of flexible materials such as described, or may be constructed of hard rigid materials such as plastic. The solar panel assembly may be molded to define and fit the contours of the bag.

The bag may hold additional bags such as the laptop sleeve mentioned above for carrying a laptop computer. As mentioned, the laptop sleeve is clipped on the top of the interior of the bag with clips 30 (FIG. 4) so that it hangs from the top of the interior. The laptop sleeve is large enough to hold a small, medium, large, or extra large laptop computer, and the sleeve includes pouches for storing AC adapters and other accessories. The sleeve may be constructed from many material such as 5 mm neoprene and padded 420D nylon.

Other systems may be used to ensure that the proper polarity is supplied from the battery to the electronic device. For example, the battery can include a polarity switch. Also, the universal connecting system wire may include a polarity switch. The device plug may be designed so that it mates with the universal plug connector in one direction only, thereby providing a single fixed polarity. An AC or DC adapter or DC car charger may optionally be plugged directly into the battery to charge the battery in situations where there is not enough light for the solar cells to operate and charge the battery.

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

1. A bag comprising:
a solar panel assembly connected to the exterior of the bag, said solar panel assembly comprising a solar panel;
a battery contained in the interior of the bag and electrically connected to said solar panel; and
a universal connecting system wire electrically connected to said battery.

2. The invention of claim 1 further comprising a bag wire routing channel connected to the interior, wherein said universal connecting system wire is routed through said bag wire routing channel.

3. The invention of claim 1 wherein said solar panel is a rigid solar panel.

4. The invention of claim 1 wherein said solar panel is a flexible solar panel.

5. The invention of claim 1 wherein said solar panel assembly comprises at least one additional solar panel.

6. The invention of claim 5 wherein said solar panel and said at least one additional solar panel are electrically connected in parallel.

7. The invention of claim 1 wherein said solar panel assembly further comprises:
an assembly front;
a reinforcing ring attached to said assembly front; and
an assembly back;
wherein said assembly front comprises an aperture for displaying said solar panel;
wherein said assembly back is connected to said assembly front to form a solar panel pocket; and
wherein said solar panel is secured in said solar panel pocket between said reinforcing ring and said assembly back.

8. The invention of claim 7 further comprising a zipper on said assembly back for allowing access to said solar panel pocket.

9. The invention of claim 7 wherein said assembly front comprises a water draining hole.

10. The invention of claim 1 wherein said solar panel assembly is connected to the exterior such that said solar panel assembly has a solar panel assembly angle of around between 55 degrees and 80 degrees.

11. The invention of claim 1 further comprising at least one strap connected to the exterior, said at least one strap comprising a strap wire routing channel.

12. The invention of claim 11 wherein said strap wire routing channel comprises exit apertures.

13. The invention of claim 11 wherein said universal connecting system wire is routed through said strap wire routing channel.

14. The invention of claim 13 further comprising a phone pouch connected to said at least one strap, wherein said universal connecting system wire emerges from said strap wire routing channel close to said phone pouch.

15. The invention of claim 1 further comprising at least one strap comprising a padded shoulder portion connected to a first end of the exterior at a first location, a buckle connected to said padded shoulder portion, and an adjustable strap webbing portion connected to a second end of the exterior at a second location, wherein said adjustable strap webbing portion is engaged through said buckle, wherein said adjustable strap webbing portion further comprises extra webbing securing means for securing said adjustable strap webbing portion.

16. The invention of claim 1 further comprising a charge indicator electrically connected to said at least one solar panel, said charge indicator comprising an identifying logo, wherein at least a portion of said identifying logo is operable to be illuminated.

17. The invention of claim 16 further comprising a light emitting diode for illuminating the portion of said identifying logo.

18. The invention of claim 1 wherein said battery comprises a charging circuit comprising an input, and a voltage regulator output circuit comprising and output.

19. The invention of claim 18 wherein the output is selectable among a plurality of output voltages.

20. The invention of claim 18 wherein the plurality of output voltages include 3.7 volts, 5 volts, 6 volts, and 7.2 volts.

21. The invention of claim 18 wherein said battery is one of the following: a lithium-ion battery, a nickel metal hydride battery, or a nickel-cadmium (NiCd) battery.

22. The invention of claim 18 wherein the input is connected to an external power supply.

23. The invention of claim 18 wherein said universal connecting system wire comprises:
wires for carrying electric current;
a battery connector connected to a first end of said wires for connecting to the output; and
a universal plug connector connected to a second end of said wires.

24. The invention of claim 23 wherein said universal plug connector comprises a polarity aligning mark.

25. The invention of claim 24 further comprising a device plug adapted to mate with said universal plug connector.

26. The invention of claim 25 wherein said device plug comprises a polarity aligning mark.

27. The invention of claim 26 wherein said device plug is a barrel plug, a phone plug, a cell phone power plug, a PDA power plug, a camera power plug, a game machine power plug, a portable music player power plug, a portable media device power plug, a light emitting diode flashlight plug, a universal serial bus plug, a power inverter, or a car charger socket.

28. The invention of claim 26 wherein said device plug further comprises circuitry.

29. The invention of claim 1 further comprising a laptop sleeve connected to the top of the interior of the bag.
